(19) United States
(12) Patent Application Publication
(10) Pub. No.: US 2011/0109614 A1
(43) Pub. Date: May 12, 2011

(54) DRIVING CIRCUIT AND METHOD OF LIGHT EMITTING DIODE

(75) Inventor: Jia-Shyang Wang, Hsinchu (TW)

(73) Assignee: SILICON TOUCH TECHNOLOGY INC., Hsinchu (TW)

(21) Appl. No.: 12/617,700

(22) Filed: Nov. 12, 2009

(51) Int. Cl. G09G 5/00

(52) U.S. Cl. 345/212

(57) ABSTRACT

A driving circuit and a driving method of an light emitting diode (LED) are provided. The driving circuit includes a current source, a voltage source, a voltage detecting unit, a memory unit, and a control unit. The voltage detecting unit detects a present voltage value of the LED. The memory unit records a previous voltage value of the LED. The control unit controls the voltage source to provide a pre-charge voltage to the LED in a driving period, and to cease providing the pre-charge voltage when the present voltage value is no longer less than the previous voltage value. The voltage level of the pre-charge voltage is determined by the previous voltage value. The control unit controls the current source to provide a driving current to the LED in the driving period.

### BACKGROUND OF THE INVENTION

1. Field of the Invention

The invention generally relates to a driving circuit, and more particularly, to a driving circuit and a driving method of a light emitting diode (LED).

2. Description of Related Art

Due to energy saving needs, applications of the LED have become more prevalent. For example, since the organic light emitting diode (OLED) possesses high luminescence efficiency along with a low current requirement, the OLED may be better suited to satisfy the energy saving needs. Using the display panel for instance, the driving method of an OLED display panel can be categorized into voltage driven and current driven. In order to achieve uniform brightness, typically the current driving method is adopted. As previously mentioned, the OLED possesses a high luminescence efficiency. Therefore, the OLED only requires a small current to provide satisfactory brightness. In darker grayscale display modes, the current requirement for the OLED is even less. However, larger dimension display panels typically have a larger parasitic capacitance. When current driving a large dimension OLED display panel, the parasitic capacitance enlarges a settling time of the OLED. With development trending toward higher resolution, the current programming time for each of the OLEDs in the display panel must be curtailed. The conventional current driving methods cannot satisfy the settling time requirement of the large dimension OLED display panel.

Various methods have been proposed for decreasing the settling time. For instance, by pre-charging, the voltage of the OLED can be pulled up aforehand to a certain constant voltage. However, because the pre-charge voltage is at a constant level, this conventional speed increasing method is limited by an mismatch issue between each OLED. U.S. Patent Publication No. 2006/0208961 proposes a differentiator framework. However, this framework is susceptible to noise interference. Moreover, such a framework may also have stability issues. These two deficiencies have limited the practicality of the proposed method.

### SUMMARY OF THE INVENTION

An aspect of the invention provides a driving circuit and a driving method of an LED capable of overcoming an mismatch issue between different LEDs and shortening a settling time needed to light up the LED.

An aspect of the invention provides a driving circuit of an LED including a current source, a voltage source, a voltage detecting unit, a memory unit, and a control unit. The current source and the voltage source are both coupled to the power terminal of the LED. The voltage detecting unit detects a voltage value at the power terminal of the LED. The memory unit is coupled to the voltage detecting unit so as to record the voltage value at the power terminal of the LED. The control unit is coupled to the voltage source, the current source, the voltage detecting unit, and the memory unit. The control unit controls the voltage source to provide a pre-charge voltage to the LED during a driving period, until the voltage value at the power terminal of the LED is no longer less than the voltage value recorded by the memory unit, and ceasing to provide the pre-charge voltage to the LED at this time. A voltage level of the pre-charge voltage is determined according to the voltage value recorded by the memory unit. The control unit controls the current source to provide a driving current to the LED during the driving period.

Another aspect of the invention provides a driving method of an LED including detecting a present voltage at a power terminal of the LED, and recording a previous voltage at the power terminal of the LED. During a driving period, a current source is controlled to provide a current to the LED. During the driving period, the voltage source is controlled to provide a pre-charge voltage to the LED until the present voltage at the power terminal is no longer less than the previous voltage, and ceasing to provide the pre-charge voltage to the LED at this time. A voltage level of the pre-charge voltage is determined according to the previous voltage.

In summary, embodiments of the invention dynamically determine the voltage level of the pre-charge voltage according to a stable voltage during a previous driving period. Thereafter, in the beginning of the present driving period, the pre-charge voltage is provided to the LED until the present voltage of the LED is no longer less than the previous voltage, ceasing to provide the pre-charge voltage to the LED at this time, and switching to current driving mode. Therefore, the driving circuit and driving method according to embodiments of the invention are capable of overcoming the mismatch issue between different LEDs and shortening the settling time needed to light up the LED.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic driving circuit diagram of an LED in accordance with an embodiment of the invention.

FIG. 2 is a schematic circuit diagram of a driving circuit depicted in FIG. 1 in accordance with another embodiment of the invention.

FIG. 3 is a timing diagram illustrating each of the signals depicted in FIG. 2 in accordance with an embodiment of the invention.

FIG. 4 is a schematic circuit diagram of the driving circuit depicted in FIG. 1 in accordance with another embodiment of the invention.

### DESCRIPTION OF EMBODIMENTS

In the description hereafter, a driving circuit is exemplified by an OLED display panel. However, the LED in the embodiments described below should not be construed as being limited to the OLED. For example, the driving circuit may also be exemplified by an LED display board (e.g., advertising board) in the embodiments described hereinafter.

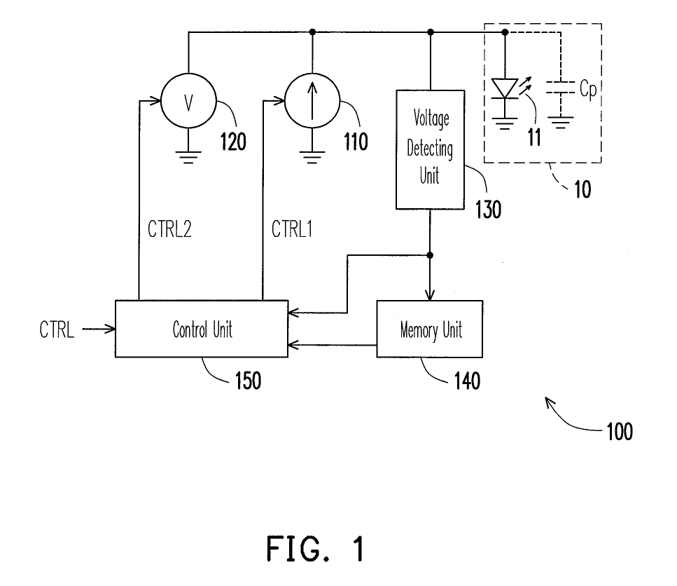

FIG. 1 is a schematic driving circuit diagram of an LED in accordance with an embodiment of the invention. A driving circuit 100 drives a pixel 10 of an OLED display panel according to an external control signal CTRL. By adjusting the external control signal CTRL, an average brightness of an LED 11 is modified. The aforementioned adjustment method of the external control signal CTRL can be pulse-width modulation (PWM), pulse-frequency modulation (PFM), pulse-skipping modulation (PSM), or other suitable adjustment methods. Herein, the LED 11 (e.g., an OLED) and an parasitic capacitor Cp represent an equivalent circuit of the pixel 10.

Referring to FIG. 1, the driving circuit 100 includes a current source 110, a voltage source 120, a voltage detecting unit 130, a memory unit 140, and a control unit 150. The current source 110 and voltage source 120 are parallel-coupled to a power terminal (e.g., an anode) of the LED 11. A cathode of the LED 11 is coupled to ground. The voltage detecting unit 130 detects a voltage value of the LED 11, and thereafter a detection result is recorded in the memory 140. In other words, the memory unit 140 records a previous voltage value of the LED 11. Therefore, the control unit 150 can receive the previous voltage value of the LED 11, as well as a present voltage value of the LED 11 from the voltage detecting unit 130.

According to a control signal CTRL1, the control unit 150 controls the current source 110 to provide a driving current to the LED 11 in a driving period. Moreover, according to a control signal CTRL2, the control unit 150 controls the voltage source 120 to provide a pre-charge voltage to the LED 11 in the driving period, until the present voltage value of the LED 11 is no longer less than the previous voltage value recorded by the memory unit 140. At this time, according to the control signal CTRL2, the control unit 150 controls the voltage source 120 to stop providing the pre-charge voltage to the LED 11. According to the previous voltage value recorded by the memory unit 140, The control unit 150 dynamically adjusts a voltage level of the output pre-charge voltage from the voltage source 120.

Those applying the present embodiment of the invention can implement the current source 110, the voltage source 120, the voltage detecting unit 130, the memory unit 140, and the control unit 150 in any suitable manner. For example, the voltage detecting unit 130 may include an analog-to-digital converter (ADC). This ADC can convert the voltage at the power terminal of the LED 11 into a digital value, and write this digital value into the memory unit 140. The control unit 150 may be a micro controller. This micro controller can respectively receive the previous voltage value and the present voltage value from the memory unit 140 and the voltage detecting unit 130, and thereafter perform a comparison. According to a comparison result, this micro controller can output the control signal CTRL2 in digital mode to determine the pre-charge voltage level, and control the voltage source 120 to output (or cease to output) the pre-charge voltage to the LED 11. The voltage source 120 may be a digital controllable voltage source or a programmable voltage source. Similarly, this micro controller can output the control signal CTRL1 in digital mode to control the current source 110 to output (or cease to output) the driving current to the LED 11. In some embodiments of the invention, the current source 110 may be a digital controllable current source or a programmable current source. Therefore, according to the control signal CTRL1, the control unit 150 can control the current source 110 to modify the value of the driving current.

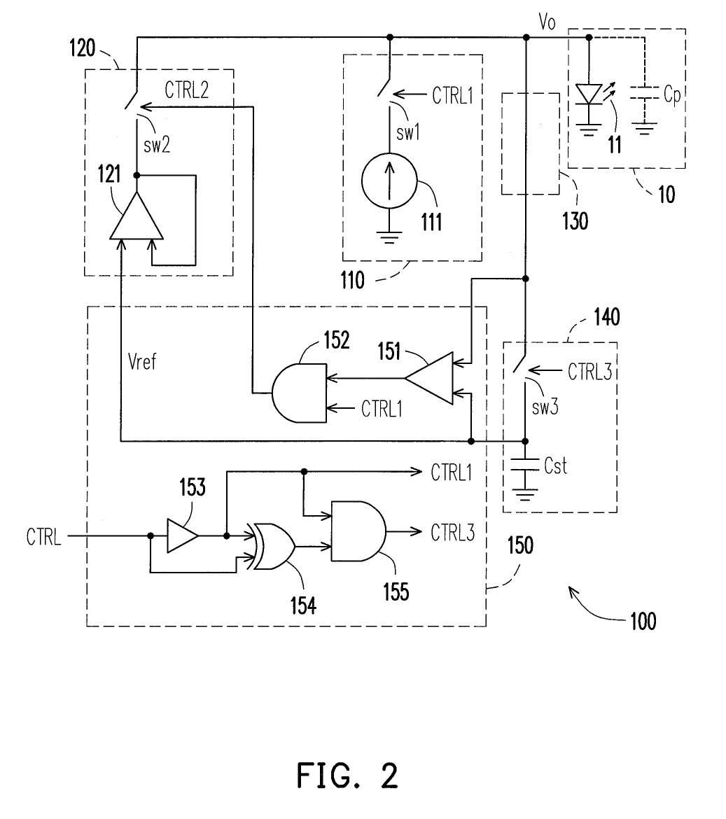

The aforementioned embodiments represent only an exemplary example of the invention. Persons having ordinary skill in the art may choose to implement the invention in any suitable manner. For example, FIG. 2 is a schematic circuit diagram of the driving circuit 100 depicted in FIG. 1 in accordance with another embodiment of the invention. Referring to FIG. 2, the current source 110 includes a first switch SW1 and a constant current source 111. The first switch SW1 has a first terminal coupled to the power terminal (e.g., the anode) of the LED 11, and a control terminal coupled to the control unit 150 so as to receive the control signal CTRL1. The constant current source 111 is coupled to a second terminal of the first switch SW1. The voltage source 120 includes a second switch SW2 and a gain amplifier 121. The second switch SW2 has a first terminal coupled to the power terminal of the LED 11, and a control terminal coupled to the control unit 150 so as to receive the control signal CTRL2. An output terminal of the gain amplifier 121 is coupled to a second terminal of the second switch SW2, and an input terminal of the gain amplifier 121 receives a reference voltage Vref provided by the control unit 150. According to the voltage value recorded by the memory unit 140, the control unit 150 determines a voltage level of the reference voltage Vref. In the present embodiment of the invention, the gain amplifier 121 may be an unit gain amplifier.

In the present embodiment, the voltage detecting unit 130 includes a conductive line. A first terminal of the conductive line is coupled to the power terminal of the LED 11, and a second terminal of the conductive line is coupled to the memory unit 140. The memory unit 140 includes a third switch SW3 and a capacitor Cst. The second switch SW3 has a first terminal coupled to the power terminal of the LED 11 via the conductive line (voltage detecting unit 130), and a control terminal coupled to the control unit 150 so as to receive the control signal CTRL3. A first terminal of the capacitor Cst is coupled to a second terminal of the third switch SW3, and a second terminal of the capacitor Cst is coupled to ground.

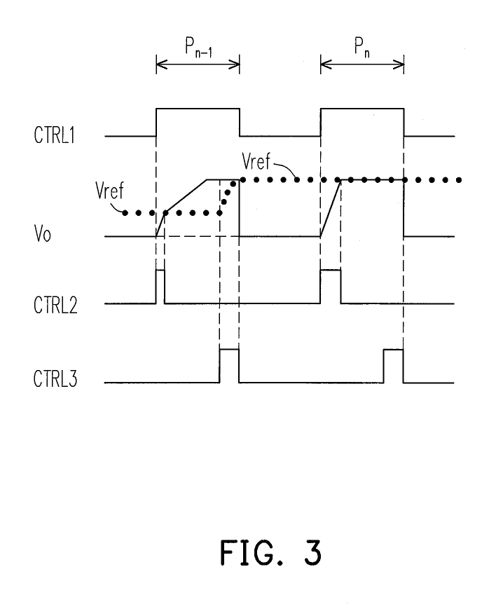

FIG. 3 is a timing diagram illustrating each of the signals depicted in FIG. 2 in accordance with an embodiment of the invention. Referring to FIGS. 2 and 3, the first switch SW1 is turned on according to the control signal CTRL1, whereby the constant current source 111 can provide the driving current to the LED 11 in a previous driving period (e.g., an n−1^{th} period Pₙ₋₁). During this n−1^{th} driving period Pₙ₋₁, according to the voltage value recorded by the capacitor Cst, the control unit 150 determines the voltage level of the reference voltage Vref. Moreover, during this n−1^{th} period Pₙ₋₁, the control unit 150 controls the second switch SW2 according to the control signal CTRL2, whereby the gain amplifier 121 can output the pre-charge voltage corresponding to the reference voltage Vref to the LED 11. Therefore, a voltage V0 at the power terminal of the LED 11 can be rapidly pulled up to substantially the same voltage level as the reference voltage Vref. The control unit 150 turns off the second switch SW2 according to the control signal CTRL2 when the voltage V0 at the power terminal of the LED 11 is no longer less than the voltage recorded by the capacitor Cst. At this time, the constant current source 111 continuously provides the driving current to the LED 11 via the first switch SW1, until the n−1^{th} driving period Pₙ₋₁ ends. Since the constant current source 111 provides the driving current to the LED 11 and charges the parasitic capacitor Cp, after the voltage source 120 ceases to output the pre-charge voltage, the voltage V0 at the power terminal of the LED 11 can still rise.

When the voltage V0 at the power terminal of the LED 11 is stable (e.g., at the end of the n−1^{th} driving period Pₙ₋₁), the third switch SW3 is turned off according to the control signal CTRL3, whereby the voltage V0 at the power terminal of the LED 11 is recorded by the capacitor Cst. In other words, after the n−1^{th} driving period Pₙ₋₁ ends, the first, second, and third switches SW1, SW2, and SW3 are all turned off, whereby the capacitor Cst can maintain the voltage value of the voltage V0 in the n−1^{th} driving period Pₙ₋₁.

When the control signal CTRL1 again changes to a logic high level, a next driving period begins (e.g., an n^{th} period Pₙ). During the n^{th} period Pₙ, the control signal CTRL2 controls the second switch SW2, whereby the gain amplifier 121 rapidly pulls up the voltage V0 to the voltage level of the reference voltage Vref (i.e. the previous voltage at the power terminal of the LED 11, also the voltage V0 in the n−1^{th} driving period Pₙ₋₁). Therefore, according to the present embodiment, the voltage level of the pre-charge voltage is dynamically determined in accordance with the stable voltage of the previous driving period. Since the pre-charge voltage has a dynamic voltage level, the driving circuit 100 and the driving method thereof in the present embodiment can overcome the mismatch issue of the LED 11, and effectively shorten the settling time needed to light up the LED 11.

The circuit producing the aforementioned controls signals CTRL1, CTRL2, and CTRL3 may be implemented in any suitable manner, and the control unit 150 depicted in FIG. 2 only represents one exemplary implementation. In FIG. 2, the gain amplifier 121 directly couples to the first terminal of the capacitor Cst through an internal conductive line of the control unit 150. The control unit 150 includes a comparator 151 and a first AND gate 152. A first input terminal of the comparator 151 is coupled to the power terminal of the LED 11, and a second terminal of the comparator 151 is coupled to the first terminal of the capacitor Cst. Therefore, the comparator 151 can compare the previous voltage value and the present voltage value of the LED 11. A first input terminal of the AND gate 152 is coupled to an output terminal of the comparator 151, and a second input terminal of the AND gate 152 receives the control signal CTRL1. The output terminal of the first AND gate 152 is coupled to the voltage source 120. The first AND gate 152 outputs the control signal CTRL2 to the control terminal of the second switch SW2, so as to control whether the voltage source 120 provides the pre-charge voltage to the LED 11.

Typically speaking, the aforementioned CTRL1 can be directly provided by an external apparatus (not drawn). In the present embodiment of the invention, the control unit 150 delays the external control signal CTRL a predetermined time to obtain the control signal CTRL1. Therefore, the control unit 150 depicted in FIG. 2 further includes a delay circuit 153, an exclusive OR (XOR) gate 154, and a second AND gate 155. An input terminal of the delay circuit 153 is coupled to the external control signal CTRL, and an output terminal of the delay circuit 153 provides the control signal CTRL1 to the first switch SW1 and the AND gate 152. This delay circuit 153 may be a buffer or any suitable circuit or device capable of providing a time delay.

A first input terminal of the XOR gate 154 is coupled to an output terminal of the delay circuit 153, and a second terminal of the XOR gate 154 receives the external control signal CTRL. A first input terminal of the second AND gate 155 is coupled to the output terminal of the delay circuit 153, and a second terminal of the AND gate 155 is coupled to the output terminal of the XOR gate 154. An output terminal of the second AND gate is coupled to the control terminal of the third switch SW3. Consequently, the control unit 150 can control the third switch SW3 according to the control signal CTRL3, whereby the voltage V0 at the power terminal of the LED 11 can be recorded in the capacitor Cst before the driving period (e.g., the n^{th} period Pₙ) ends.

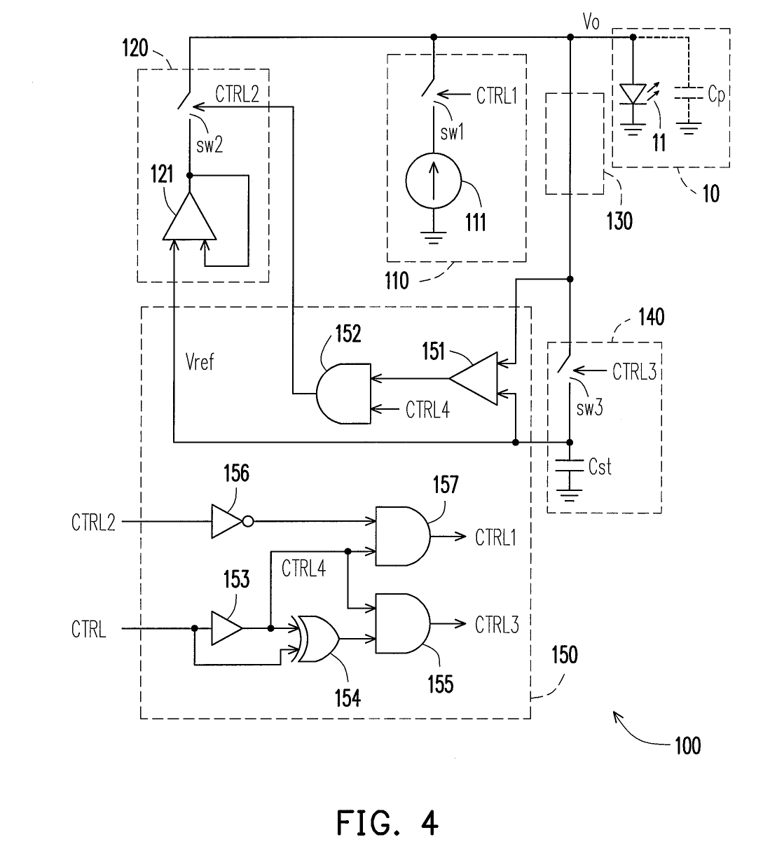

FIG. 4 is a schematic circuit diagram of the driving circuit 100 depicted in FIG. 1 in accordance with another embodiment of the invention. Since the driving circuit depicted in FIG. 4 is similar to the driving circuit depicted in FIG. 2, the like parts are not described again. A difference between the two resides in the control unit 150 of the driving circuit 100 depicted in FIG. 4 further including a NOT gate 156 and a third AND gate 157. An input terminal of the NOT gate 156 is coupled to an output terminal of the first AND gate 152, so as to receive the control signal CTRL2. A first input terminal of the third AND gate 157 is coupled to an output terminal of the NOT gate. A second input terminal of the third AND gate 157 is coupled to the output terminal of the delay circuit 153, so as to receive a control signal CTRL4. The second and third AND gates 155 and 157 are simultaneously provided with the control signal CTRL4. An output terminal of the third AND gate provides the control signal CTRL1 so as to control the first switch SW1 of the current source 110.

In other words, the difference between the driving circuits of FIGS. 2 and 4 resides in the current source 110 of the driving circuit 100 depicted in FIG. 4. When the driving period (e.g., the n^{th} period Pₙ) begins for the driving circuit 100 depicted in FIG. 4, the current source 110 is disabled when the voltage source 120 provides the pre-charge voltage to the LED 11. Only when the voltage source 120 ceases to provide the pre-charge voltage, the current source 110 can be enabled to provide the driving current to the LED 11.

In light of the foregoing, an above-described embodiment provides a driving method of an LED 11. The driving method includes: detecting the present voltage at the power terminal of the LED 11; recording the previous voltage at the power terminal of the LED 11; providing the driving current to the LED 11 during the driving period; and controlling the voltage source 120 to provide the pre-charge voltage to the LED 11 during the driving period until the present voltage is no longer less than the previous voltage, ceasing to provide the pre-charge voltage to the LED 11 at this time. The voltage level of the pre-charge voltage is determined by the previous voltage.

The steps to record the previous voltage at the power terminal of the LED 11 include recording a voltage Po as the previous voltage, during a previous driving period when the voltage Po at the power terminal of the LED 11 is stable.

The steps to control the voltage source 120 to provide the pre-charge voltage to the LED 11 include: adjusting the pre-charge voltage according to the previous voltage; comparing the present voltage with the previous voltage; providing the pre-charge voltage to the LED 11 during the driving period, if the present voltage is less than the previous voltage; and ceasing to provide the pre-charge voltage if the present voltage is no longer less than the previous voltage.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A driving circuit of a light emitting diode (LED), comprising:
a current source coupled to a power terminal of the LED;
a voltage source coupled to the power terminal of the LED;
a voltage detecting unit detecting a voltage value of the power terminal of the LED;
a memory unit coupled to the voltage detecting unit, the memory unit configured to record a voltage value of the LED; and
a control unit coupled to the voltage source, the current source, the voltage detecting unit, and the memory unit, the control unit configured to control the voltage source to provide a pre-charge voltage to the LED in a driving period, to control the voltage source to cease providing the pre-charge voltage to the LED when the voltage value at the power terminal of the LED is no longer less than the voltage value recorded by the memory unit, and to control the current source to provide a driving current to the LED in the driving period, wherein a voltage level of the pre-charge voltage is determined according to the voltage value recorded by the memory unit.

2. The driving circuit of the LED as claimed in claim 1, wherein the current source comprises:
a first switch having a first terminal coupled to the power terminal of the LED, and a control terminal coupled to the control unit; and
a constant current source coupled to a second terminal of the first switch.

3. The driving circuit of the LED as claimed in claim 1, wherein the voltage source comprises:
a second switch having a first terminal coupled to the power terminal of the LED, and a control terminal coupled to the control unit; and
a gain amplifier having an output terminal coupled to the second terminal of the second switch, and an input terminal to receive a reference voltage provided by the control unit, wherein the control unit determines a voltage level of the reference voltage according to the voltage value recorded by the memory unit.

4. The driving circuit of the LED as claimed in claim 3, wherein the gain amplifier is an unit gain amplifier.

5. The driving circuit of the LED as claimed in claim 1, wherein the voltage detecting unit comprises an analogue-to-digital converter (ADC) configured to convert the voltage at the power terminal of the LED into a voltage value, and writing the voltage value into the memory unit.

6. The driving circuit of the LED as claimed in claim 1, wherein the memory unit comprises:
a third switch having a control terminal coupled to the control unit; and
a capacitor coupled to a second terminal of the third switch;
wherein the voltage detecting unit comprises a conductive line having a first terminal coupled to the power terminal of the LED, and a second terminal coupled to a first terminal of the third switch.

7. The driving circuit of the LED as claimed in claim 6, wherein the control unit comprising:
a comparator having a first input terminal coupled to the power terminal of the LED, and a second terminal coupled to the capacitor; and
a first AND gate having a first input terminal coupled to an output terminal of the comparator, a second input terminal to receive a first control signal, and an output terminal coupled to the voltage source to control whether the voltage source provides the pre-charge voltage;
wherein the voltage source comprises an unit gain amplifier coupled to the capacitor via the control unit.

8. The driving circuit of the LED as claimed in claim 7, wherein the voltage source further comprises a second switch having a first terminal coupled to the power terminal of the LED, a second terminal coupled to an output terminal of the unit gain amplifier, and a control terminal coupled to the output terminal of the first AND gate.

9. The driving circuit of the LED as claimed in claim 7, wherein the control unit further comprises:
a delay circuit having an input terminal to receive an external control signal;
an XOR gate having a first input terminal coupled to an output terminal of the delay circuit, and a second input terminal to receive the external control signal; and
a second AND gate having a first input terminal coupled to the output terminal of the delay circuit, a second input terminal coupled to an output terminal of the XOR gate, and an output terminal coupled to the control terminal of the third switch.

10. The driving circuit of the LED as claimed in claim 9, wherein the current source comprises:
a first switch having a first terminal coupled to the voltage terminal of the LED, and a control terminal coupled to the output terminal of the delay circuit; and
a constant current source coupled to a second terminal of the first switch.

11. The driving circuit of the LED as claimed in claim 9, wherein the control unit further comprises:
a NOT gate having an input terminal coupled to the output terminal of the first AND gate; and
a third AND gate having a first input terminal coupled to an output terminal of the NOT gate, a second input terminal coupled to the output terminal of the delay circuit, and an output controlling the current source.

12. The driving circuit of the LED as claimed in claim 11, wherein the current source comprises:
a first switch having a first terminal coupled to the power terminal of the LED, and a control terminal coupled to the output terminal of the third AND gate; and
a constant current source coupled to a second terminal of the first switch.

13. A driving method of an LED, comprising:
detecting a present voltage at a power terminal of the LED;
recording a previous voltage at the power terminal of the LED;
controlling a current source to provide a driving current to the LED during a driving period; and
during the driving period, controlling a voltage source to provide a pre-charge voltage to the LED until the present voltage is no longer less than the previous voltage, and ceasing to provide the pre-charge voltage to the LED at this time, wherein a voltage level of the pre-charge voltage is determined according to the previous voltage.

14. The driving method of the LED as claimed in claim 13, wherein controlling a voltage source to provide a pre-charge voltage to the LED comprises:
adjusting the pre-charge voltage according to the previous voltage;
comparing the present voltage with the previous voltage;
providing the pre-charge voltage to the LED during the driving period, if the present voltage is less than the previous voltage; and
ceasing to provide the pre-charge voltage if the present voltage is no longer less than the previous voltage.

15. The driving method of the LED as claimed in claim 13, wherein recording a previous voltage at the power terminal of the LED comprises:
during a previous driving period, recording the voltage at the power terminal as the previous voltage, when the voltage at the power terminal of the LED is stable.
